(19) United States
(12) Patent Application Publication
(10) Pub. No.: US 2001/0030668 A1
(43) Pub. Date: Oct. 18, 2001

(54) Method and system for interacting with a display

(76) Inventors: Gamze Erten, Okemos, MI (US); Fathi M. Salam, Okemos, MI (US)

Correspondence Address: Darlene P. Condra, Young & Basile, P.C., Suite 624, 3001 West Big Beaver Road, Troy, MI, 48084, US

(21) Appl. No.: 09/757,930

(22) Filed: Jan. 10, 2001

Related U.S. Application Data
(60) Provisional application No. 60/174,940, filed on Jan. 10, 2000.

(51) Int. Cl. G06F 3/00

(52) U.S. Cl. 345/863; 345/835

(57) ABSTRACT

A novel visual method and system for interacting with displays and all devices that use such displays. The system has three hardware elements, which are a display, a light sensor or camera that can register the display image and the pointing device or its effect on the display, and a pointing device that can be registered by or produces recognizable characteristics that can be registered by the light sensor or camera. The system uses a set of methods as follows: a method for detecting the display, and the pointing device on or in relation to the display, a method for establishing the correspondence between the position of the pointing device in relation to the display as it is registered by the light sensor or camera and its position in relation to the computer or display device space, a method for correcting the offsets between the position of the pointing device or effect thereof on the display as observed by the user or by the light sensor or camera, and the position of the pointer on the computer or device display space, a method for selecting or highlighting a specific item or icon on the display, a method for activating a specific process, program, or menu item represented on the display, and a method for writing, scribing, drawing, highlighting, annotating, or otherwise producing marks on the display.

### FIELD OF THE INVENTION

This invention relates to the field of computer input systems and particularly a novel visual method and system for interacting with displays and all devices that use such displays.

### BACKGROUND OF THE INVENTION

Remote controllers for TV's, VCR's, cable set top boxes and other entertainment appliances have been in common use for quite some time. However, these devices have many buttons that often confuse their users. When the devices are used to navigate through a menu, the hierarchy of menus is often too sequential and clumsy. Recently, several manufacturers have introduced “universal remote controllers” which users have to program for a specific device. When one changes batteries or switches televisions re-programming is required. These hassles are often annoying to the user. The invention introduces a truly “universal” remote control that one can far more easily replace and/or re-use.

Also, currently many remote mouse units exist to control computers and their displays (e.g., projectors or monitors). Some of these still require a flat horizontal surface for their tracker. One example is the Cordless Wheel Mouse from Logitech. Another group of remote mouse controllers are made for use during presentations and do not require a surface, but require the user to drag the pointer across the screen by operating a trackball or a dial. One example is the RemotePoint RF Cordless Mouse from Interlink Electronics. The invention provides random access to the display space and a far more versatile, facile and intuitive way to interact with the display.

Among prior art, there is a set of patents authored by Lane Hauck et. al. of San Diego that define a computer input system for a computer generating images that appear on a screen. These are listed in the References Cited and discussed in some detail below.

U.S. Pat. No. 5,181,015 is the initial patent describing a method and apparatus for calibrating an optical computer input system. The claims focus primarily on the calibration for facilitating the alignment of the screen image. U.S. Pat. No. 5,489,923 carries the same title as the first patent (U.S. Pat. No. 5,181,015) and is similar in its content. U.S. Pat. No. 5,515,079 appears to have been written when the inventors wanted to claim the computer input system, rather than their prior and subsequent more specific optical input and calibration systems. We consider this and what appears to be its continuation in U.S. Pat. No. 5,933,132 to be the most relevant prior art to this invention. This patent defines a computer input system and method based on an external light source pointed at the screen of a projector. In the continuation U.S. Pat. No. 5,933,132, a method and apparatus for calibrating geometrically an optical computer input system is described. This is to take care of the geometric errors that appear in relating the image of the projection to that of the display. However, this correction relies exclusively on the four corners of a projected rectangle and thus compensates only partially for the most obvious errors, and thus still provides a limited correction. U.S. Pat. No. 5,594,468 describes in a detailed and comprehensive manner additional means of calibrating—by which the authors mean determining the sensed signal levels that allow the system to distinguish between the user generated image (such as the light spot produced by a laser pointer) and the video source generated image that overlap on the same display screen. U.S. Pat. No. 5,682,181 is another improvement on U.S. Pat. No. 5,515,468 and is mainly concerned with superimposing an image based on the actions of the external light source on the image produced by the computer. This is done to allow the user holding the light source to accentuate the computer image.

All of the cited patents describe methods based on external proprietary hardware for image registration and signal processing. Because of the nature of the image acquisition, the methods used by the said invention of prior art differ significantly from those of this invention, which uses off-the-shelf standard hardware and software routines as embodiments of the methods described and claimed to combine them into a seamless human-machine interaction system. Moreover, the input system in prior art functions only with a specific set of pointing devices. No method for other pointing devices is provided. No correction based on the actual mouse position registered by the camera is provided. No method for a pointing device that is used outside of the real display space is provided.

### SUMMARY OF THE INVENTION

The hardware elements of a simple implementation of the invention consist of a projector, camera, and a pointing device such as a laser pointer. Some of the many intended applications of this invention is as a replacement for a computer mouse pointer and as a replacement for a computer pen or stylus. The invention can replace a common PC mouse, or a menu-driven remote control device with an arbitrary pointing device, such as a laser pointer or another light source or another pointing device with recognizable characteristics, e.g., a pen, a finger worn cover, e.g., thimble, a glove or simply the index finger of a hand. By implementing a system defined by this invention, one can use a pointing device (e.g., a laser pointer) during a computer presentation not only to point to specific locations on the screen projected by an LCD projector or a rear projection screen display, but also to interact with the computer to perform all functions that one can ordinarily perform with a PC mouse or remote control for the display. The invention can also be interfaced with and operate in tandem with voice-activated systems. The data from the camera can be processed by the system to (1) determine the position of the location of the pointing device (e.g., the reflection of the laser pointer or the position of the thimble) on the display, (2) position the mouse pointer at the corresponding screen position, and (3) “click” the mouse when a programmable pre-determined pointer stroke or symbol is detected, such as a blinking laser spot or a tap of the thimble. All of these features allow the user unprecedented convenience and access to a vast variety of programmable remote control functions with only an ordinary pointing device. In the same scenario, the user can also annotate the presentation or create a presentation on any ordinary board or wall surface, by using the pointing device as a stylus. A remote control application of the invention in a home entertainment setting uses a laser pointer.

Displays, light sensors or cameras and pointing devices of the invention can be selected from a variety of commercially available hardware devices. No special hardware is required. The invention also defines methods of using the said hardware to create a seamless visual interaction system. The methods, too, can work with a variety of display, camera, and pointing devices. Future display devices could incorporate a camera within the display to achieve this type of functionality in a single device.

The invention can thus be used as a general-purpose tool for visual interaction with a PC (or PC-like device or a TV projection screen) through its display using only a common pointing device, such pointing device not having to contain any special mechanical, electronic or optical mechanism or computing or communication apparatus. The invention can also work in tandem with a common PC mouse, overriding the common mouse only when the user points the designated pointing device onto the projected display area.

### BRIEF DESCRIPTION OF THE DRAWINGS

The description herein makes reference to the accompanying drawings wherein like reference numerals refer to like parts throughout the several views, and wherein:

FIG. 1 shows hardware elements used in the present invention including a projector, camera and a pointing device, such as a laser pointer;

FIG. 2 shows a user with the pointing device to annotate a presentation on a wall surface;

FIG. 3 shows a user with a remote control to control entertainment components on a wall surface;

FIG. 3a shows an enlarged view of the entertainment components;

FIG. 4 shows elements of the system using a thimble as the pointing device;

FIGS. 5-11 show the visual steps of the system;

FIG. 12 shows one possible arrangement of the elements of the system using a rear projection display;

FIGS. 13a-13b are two examples of arrangements of the system where a light sensor cannot view an actual display;

FIG. 14 is a flowchart outlining the method for detecting a real display;

FIG. 15 is a flowchart outlining the method for registering the pointing device in a real display case;

FIG. 16 is a flowchart outlining the method for detecting a virtual display;

FIG. 17 is a flowchart outlining the method for registering the pointing device in a virtual display case;

FIG. 18 is a flowchart outlining the method for computing the mapping between a display space registered by the light sensor and the computer display;

FIGS. 19a-19d show a series of frames of the reflection of the pointing device in a lit room;

FIGS. 19e- 19h show a series of frames of the reflection of the pointing device in a dark room;

FIG. 20a shows a computer display image;

FIG. 20b shows an image of display from a light sensor;

FIG. 20c shows an image-display mapping;

FIG. 21a shows a display space image in a distorted case;

FIG. 21b shows an image of display from a light sensor in a distorted case;

FIG. 21c shows an image-display mapping in a distorted case;

FIGS. 22a-22c shows the correspondence between the image of a virtual display and the computer display;

FIGS. 23a-23c shows the correspondence between the position of the pointing device in relation to the image of the real display and the computer display;

FIG. 24a shows an acceptable positioning of the computer pointer;

FIG. 24b shows an unacceptable positioning of the computer pointer;

FIGS. 25a-25d illustrates steps for selecting an item on the display;

FIG. 26 is a flowchart outlining the method for selecting an item;

FIG. 27 is a perspective view of a light pen; and

FIG. 28 is a flowchart summarizing the system operation, which is the background or backbone process of the system.

### DESCRIPTION OF THE PREFERRED EMBODIMENT

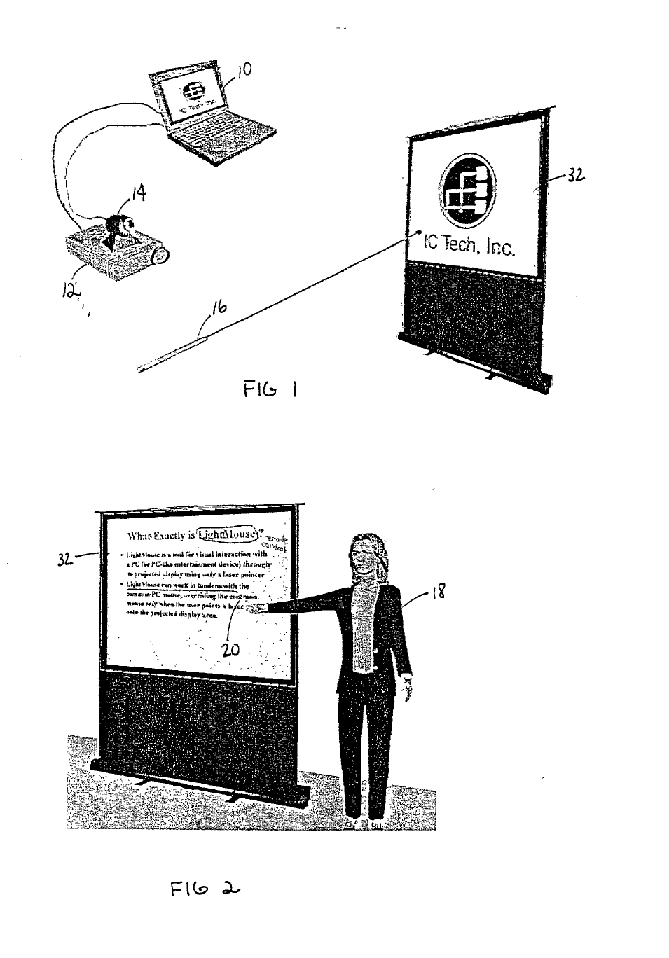

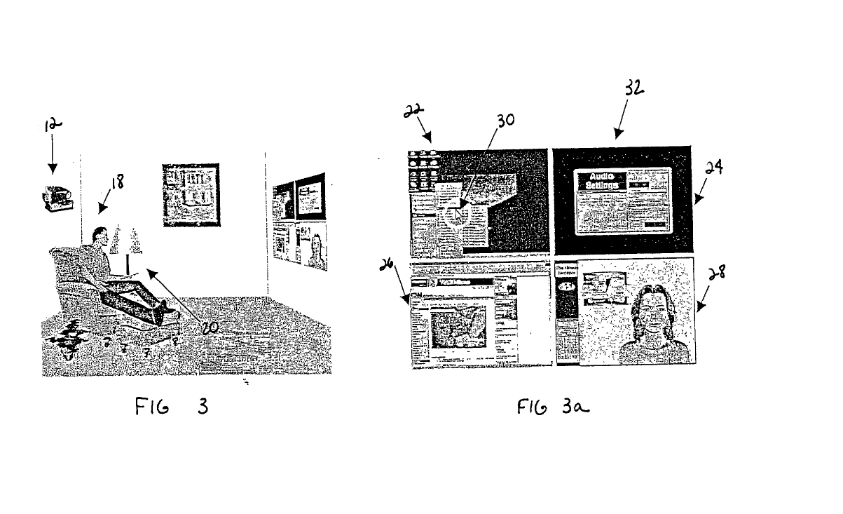

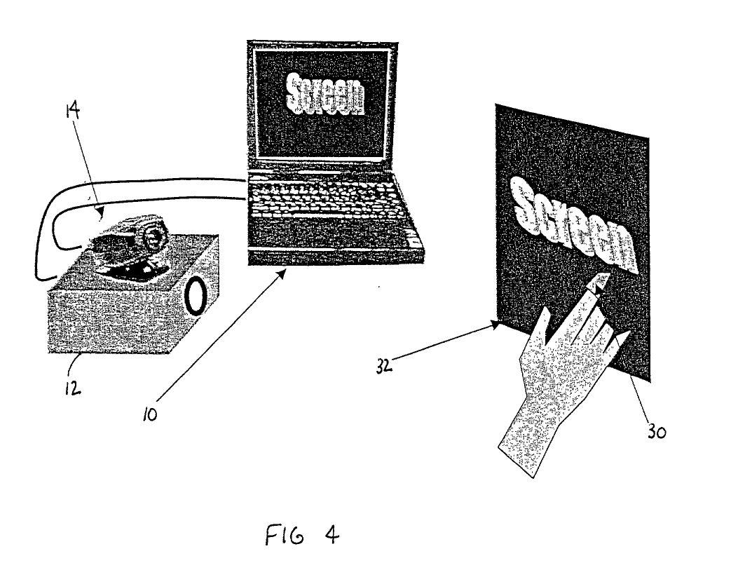

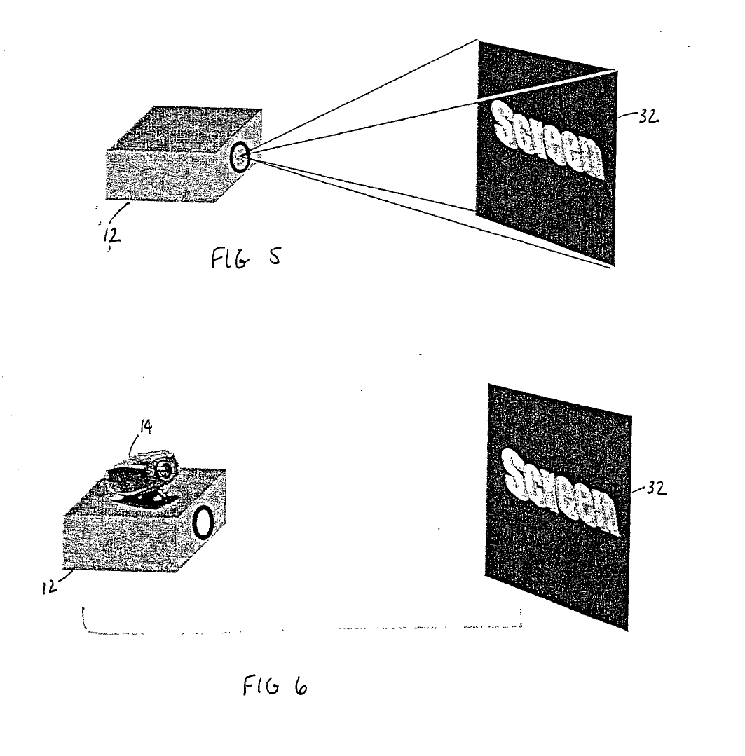

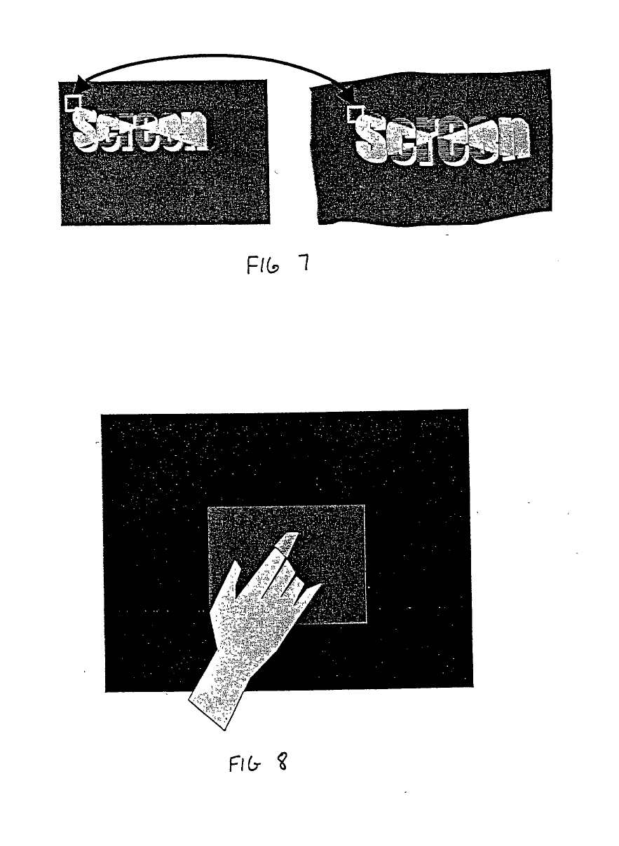

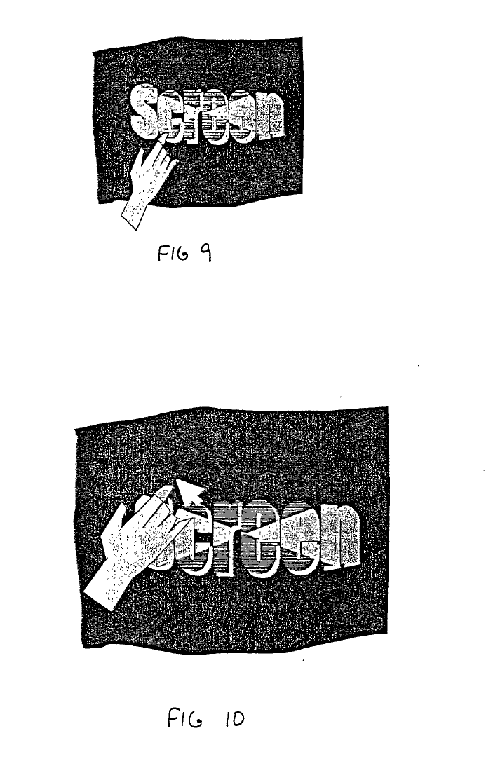

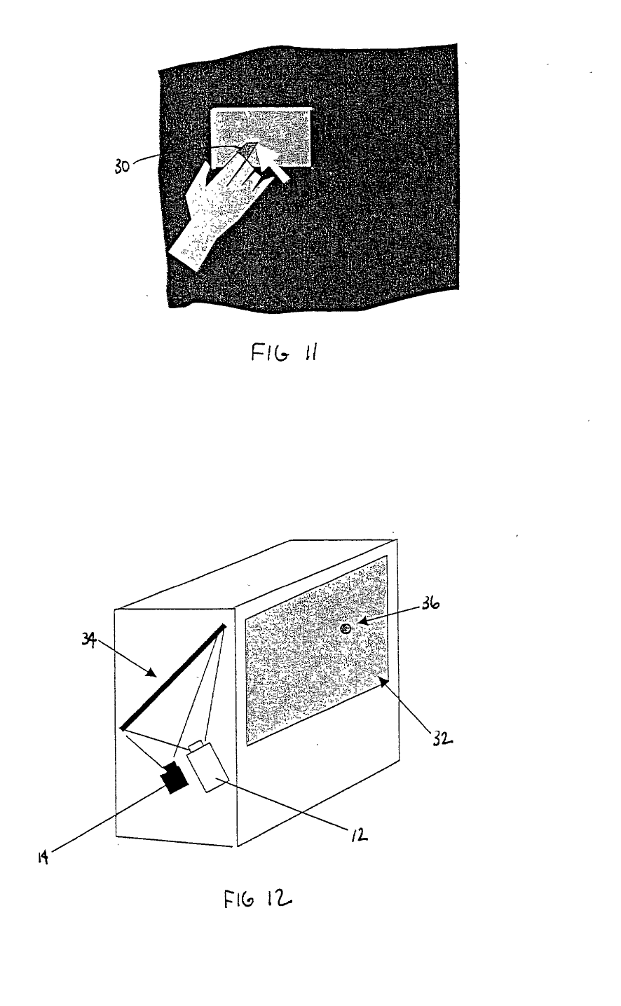

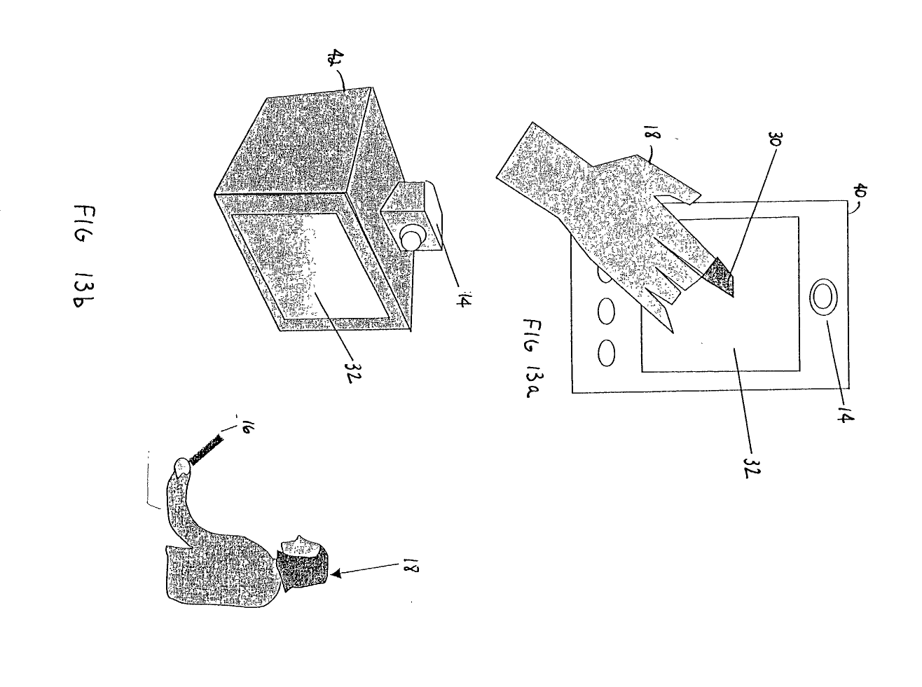

This invention relates to the field of computer input systems. The hardware elements of a simple implementation of the invention are shown in FIG. 1. Hardware elements of the invention consist of a projector 12, camera 14, and a pointing device such as a laser pointer 16. Some of the many intended applications of this invention is as a replacement for a computer mouse pointer and as a replacement for a computer pen or stylus. The invention can replace a common PC mouse, or a menu-driven remote control device with an arbitrary pointing device, such as a laser pointer 16 or another light source or another pointing device with recognizable characteristics, e.g., a pen, a finger worn cover, e.g., thimble, a glove or simply the index finger of a hand. By implementing a system defined by this invention, one can use a pointing device (e.g., a laser pointer) during a computer 10 presentation not only to point to specific locations on the screen 32 projected by an LCD projector or a rear projection screen display, but also to interact with the computer 10 to perform all functions that one can ordinary perform with a PC mouse or remote control for the display. The invention can also be interfaced with and operate in tandem with voice-activated systems. The data from the camera 14 can be processed by the system to (1) determine the position of the location of the pointing device (e.g., the reflection of the laser pointer 16 or the position of the thimble) on the display 32, (2) position the mouse pointer at the corresponding screen position, and (3) “click” the mouse when a programmable pre-determined pointer stroke or symbol is detected, such as a blinking laser spot or a tap of the thimble. All of these features allow the user 18 unprecedented convenience and access to a vast variety of programmable remote control functions with only an ordinary pointing device. In the same scenario, the user 18 can also annotate the presentation or create a presentation on any ordinary board or wall surface, by using the pointing device as a stylus. FIG. 2 illustrates one of the many scenarios where an LED light pen 20 can be used to control a computer during a presentation. The LED light pen 20 can also annotate the presentation. A remote control application of the invention having in a home entertainment setting using a laser pointer 16 is illustrated in FIG. 3. FIG. 3a shows examples on a display wall 32 or projector 12 including a PC desktop 22, audio 24, the Internet 26 and TV or cable 28. A mouse pointer at a laser light spot 30 is also shown.

The display, light sensor or camera that can register the display image and the pointing device or its reflection on the display, and a pointing device that can be registered by or produces recognizable characteristics that can be registered by the light sensor or camera can be selected from a variety of commercially available hardware devices. No special hardware is required. The invention also define methods of using said hardware to create a seamless visual interaction system. The methods, too, can work with a variety of display, camera, and pointing devices. Future display devices could incorporate a camera within the display or on the associated projection apparatus to achieve this type of functionality in a single device.

The invention can thus be used as a general-purpose tool for visual interaction with a PC (or PC-like device or a TV projection screen) through its display using only a common pointing device, such pointing device not having to contain any special mechanical, electronic or optical mechanism or computing or communication apparatus. The invention can also work in tandem with a common PC mouse, overriding the common mouse only when the user points the designated pointing device onto the projected display area.

Starting with FIG. 4, which shows the physical elements of the invention including the computer 10 connected to the display, a light sensor 14, the display 12, a colored thimble 30 as the pointing device. FIGS. 4-11 illustrate the concepts behind the invention in relation to a specific example application using a simple colored thimble pointer step by step. Elements of the system are specific to the example application. In FIG. 4, a colored thimble is the pointing device. In FIG. 5, a projector projects the display of the PC onto a wall. In FIG. 6, a camera views the projected PC display. In FIG. 7, the system algorithms establish the correspondence between the device display (left) and the projected image as it is “seen” by the camera (right). In FIG. 8, the system instructs the user to register his/her pointing device against a variety of backgrounds. During this registration process, the system compiles a list of characteristics of the pointing device, e.g. its color, shape, motion patterns, etc., which can be used later to locate the pointing device. In FIG. 9, the system algorithms take control of the PC mouse only when the camera registers sees the registered pointing device in the display area. In FIG. 10, the system steers the mouse pointer to the display location pointed to by the laser pointer. In FIG. 11, the system sends a command that “clicks” the mouse when the pointing thimble is held steady for a programmable length of time, or based on some other visual cue, e.g., tap of the thimble registered visually, or external cues by way of interaction with an external system, e.g., by sound or voice command of the user. In the example application given in FIGS. 4-11, the system serves the purpose of a one-button general purpose remote control when used with a menu displayed by or in association with the device being controlled. The menu defined on the visible display sets the variety of remotely controlled functions, without loading the remote control itself with more buttons for each added functionality. Moreover, the system allows the user random access to the display space by simply pointing to it, i.e., there is no need to mechanically “drag” the mouse pointer.

Pushing menu buttons on the display screen with a simple thimble pointer 30 is certainly only one of the applications of this invention. One can also imagine a PC, a TV, a telephone, or a videoconferencing device controlled remotely by a pointing device, e.g., laser pointer, that is pointed onto a projected image corresponding to the graphical user interface (GUI) of the device. In this scenario, the monitor or CRT or display apparatus is replaced by a projector 12, and the display is thus a projection 32 is on a surface (such as a wall). The viewable image size can be quite large without the cost or the space requirements associated with large display devices. Moreover, the pointing device (e.g., laser pointer 16) allows the user mobility and offers many more functions than an ordinary remote control can. Also, the laser pointer 16 is the size of a pen and is smaller and simpler to use than a remote control. As many people who have ever misplaced the remote control code for their TV's or VCR's can appreciate, this new device can be single button universal remote control with no preprogramming requirement. In fact, FIG. 3 illustrates this scenario.

Many types of displays that are currently available or those that will be available can be used. This includes, but is not limited to LCD projectors and rear projection displays, as well as CRT's. In case of the LCD projector, it makes practical sense to position the camera 14 near the projector 12. In case of a rear projection display 32, one option is to have the camera 14 view the backside of the visible display. FIG. 12 illustrates a possible arrangement of the system elements when used by a rear projection display. The pointing device or its reflection must be visible to the light sensor. A mirror is indicated at 34, the viewable display is indicated at 32, and reflection of the pointing device on the display is indicated at 36.

The light sensor 14 should be capable of sensing all or part of the display and the pointing device 16 or its effect 36 on the display. A one-dimensional light sensor could be used with a very simple and constrained system, but generally a two dimensional (area) light sensor could be used with a two dimensional display, although other arrangements are also possible. The elements of a light sensor are generally capable of registering a particular range of light frequencies. The light sensor may be composed of multiple sensors that are sensitive to several different ranges of light frequencies, and thus be capable of sensing multiple ranges (or colors) although that is not a requirement. The sensor needs to deliver data, which can be used by the method described below to detect the pointing device 16 or its reflection on or outside the display 32. In most cases, the sensor needs to be capable of sensing the pointing device 16 in all areas of the display 32. In this sense, it is preferable, under most circumstances for the light sensor 14 to be capable of viewing all of the display. However, this is not a limitation, as subsequent sections of this document make clear. Best resolution would be achieved with a sensor whose field of view exactly matches the whole display. In some cases, it may be preferable to use a pointing device 16 that emits or reflects light or other electromagnetic waves invisible to the human eye. In this case, if the mentioned invisible waves is a characteristic that the system relies on to distinguish the pointing device from other objects in its view, the light sensor must be able to register this characteristic of the pointing device or its reflection.

One of the distinguishing characteristics of the invention is in its versatility of allowing for a wide range of pointing devices 16. The system allows the user to select any convenient appropriate pointing object that can be registered by the light sensor. The more distinguishable the object, the better and faster the system performance will be. A light source is relatively easy to distinguish with a simple set of computations, so a light source may initially be the preferred embodiment of the invention. A laser pointer 16 or other light source is a potential pointing device that can be used. The system can also use many other types of visible (e.g., pen with LED light) or invisible (e.g., infrared) light sources so long as they are practical and can be registered by the light sensor as defined supra.

However, the invention is by no means limited to using light sources as pointing devices. A thimble 30 with a distinguishing shape or color that can be picked up by the light sensor is another potential pointing device. As the performance of the computer on which the computations are performed increases, the invention will accommodate more and more types of pointing devices, since virtually every object will be distinguishable if sufficiently sophisticated and lengthy computations can be performed.

Therefore, there are no limits on the types of pointing devices the system of this invention can use. Note that the name “pointing device” is used very loosely. It has already been mentioned that a pointing device 16 can be the index finger of one's hand. There are other ways of pointing that are more subtle and do not involve translational re-positioning of the pointing device. Imagine for example a compass that rotates and points to different directions. The length or color of the needle can be defining a point on the display. Also imagine a pointing mechanism based on the attitude of an object (such as the presentation of a wand, one's face or direction of gaze). The system of this invention can be used with such pointers, so long as the light sensor is capable of registering images of the pointing device, which can be processed to determine the attitude or directions assumed by the pointing device.

So far, only absolute positioning has been implied. This is not a limitation of the invention, either. Although in the examples shown in FIGS. 4-11, it makes sense to use the pointer as an absolute addressing mechanism for the display, it may also be convenient to use a pointer as a relative addressing mechanism. In fact, many current computer mouse devices utilize relative positioning.

There are two cases for detecting the display and the pointing device both of which can be accommodated by this invention. The first is when the light sensor can view the same display space that is being viewed by the user 18. This would be the projected image screen 32 or the monitor, which we call “the real display.” The second case is somewhat more interesting. This is the case where the light sensor cannot view the actual display, possibly because it is not in the field of view of the light sensor. Consider for example, that the light sensor is mounted on the display itself. Two examples are depicted in FIGS. 13a and 13b. FIG. 13a shows an example with a handheld computer 40 having a display 32 and a light sensor or camera 14. A colored thimble 30 is used as a pointing device. FIG. 13b shows an example with a TV console 42. The user 18 is using a colored stick or pen as the pointing device. The range of allowed positions for the pointing device (all of which should be in the field of view of the sensor) defines “the virtual display space.” The invention can still be employed, even though the display itself is not visible to the light sensor 14. We call the range of allowed positions for the pointing device (all of which should be in the field of view of the sensor) “the virtual display space.” In both of these cases, it is still necessary that the pointing device or its reflection on the display is in the field of view of the light sensor 14, at least when the user is using the system.

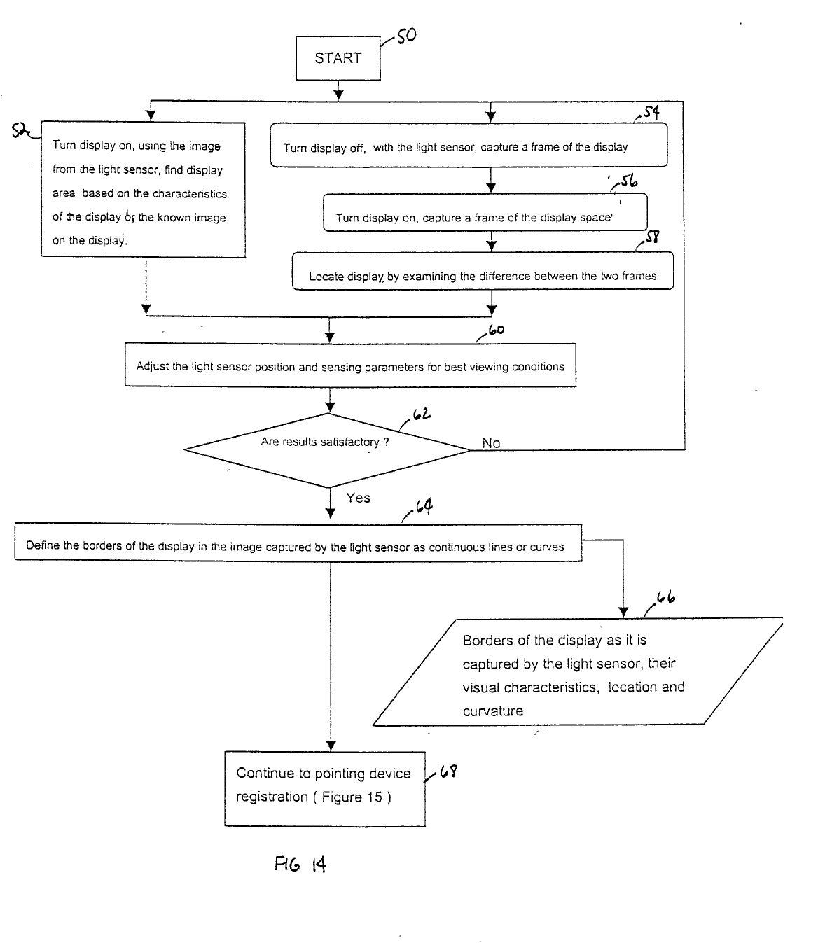

The method for the real display case is outlined in the flowcharts in FIGS. 14 and 15. In FIGS. 14 and 15, after the start step 50, two alternate paths are presented, each leading to step 60. The system can follow either path, namely 52, or 54. Step 54 then proceeds to steps 56 and 58. Step 52 details the user of the system first turning the display on, followed by the system finding the display area using the image from the light sensor, based on the characteristics of the display or the known image on the display. On the other hand, the user or the system can turn the system off, and with the light sensor capture a frame of the display (step 54), then turn the display on and capture a frame of the display space (step 56). The system then locates the display by examining the difference between the two frames (step 58). After these steps the user or the system can adjust the light sensor position and sensing parameters for best viewing conditions (step 60) and then check whether the results are satisfactory. If not satisfactory, the user or the system returns to step 50. If the results are satisfactory, the system defines the borders of the display in the image captured by the light sensor as continuous lines or curves (step 64), and outputs or stores the borders of the display as they are captured by the light sensor, their visual characteristics, location and curvature (step 66). Step 68 continues to pointing device registration. Alternately, the system may proceed to step 132, if the pointing device has already been characterized or registered. The display image used during these procedures may be an arbitrary image on the display or one or more of a set of calibration images. Step 70 instructs user to register the pointing device he/she will use. The user may select a pointing device from a list or have the system register the pointing device by allowing the pointing device to be viewed by the light sensor. Between step 70 and step 80, two alternate paths are presented. Either path can be followed. In step 72 the user is instructed to point the pointing device to various points on the display. The system then captures one or more frames of the display space with the pointing device. Alternately, steps 74, 76, and 78 can be followed. The system then can capture a frame of the display space without the pointing device (step 74), capture a frame of the display space with the pointing device (step 76), and locate pointing device by examining the difference between the two (step 78). After these steps the user or the system can adjust the light sensor or camera position and viewing angle as well as the sensing parameters for the best viewing conditions (step 80) and then check whether the results are satisfactory (step 82). If not satisfactory, the user or the system returns to step 70. If the results are satisfactory, the system has been able to determine the distinguishing characteristics of the pointing device which render it distinct from the rest of the display by analyzing the images recorded by the light sensor or camera against an arbitrary image on the display or against a set of calibration images and adjusting the light sensor or camera position, viewing angle and sensing parameters for optimum operation (step 84). In step 88, distinguishing characteristics of the pointing device against a variety of display backgrounds are outputted or stored. In step 86 the system continues to computing the mapping between the display space registered by the light sensor and the computer display 132.

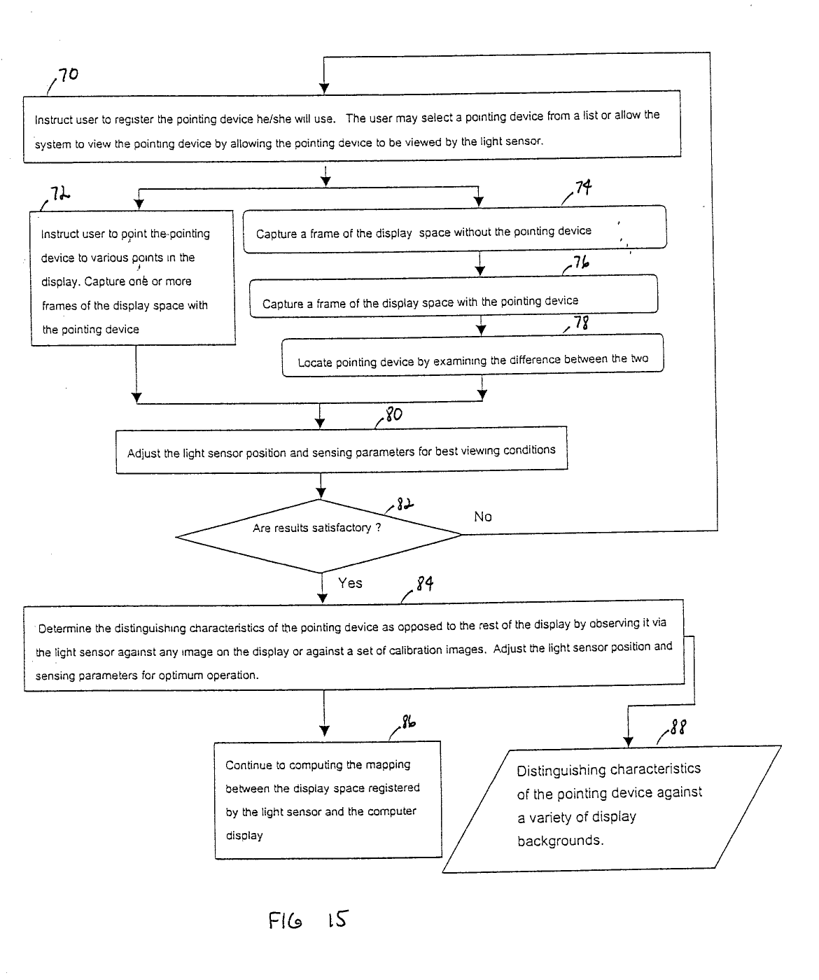

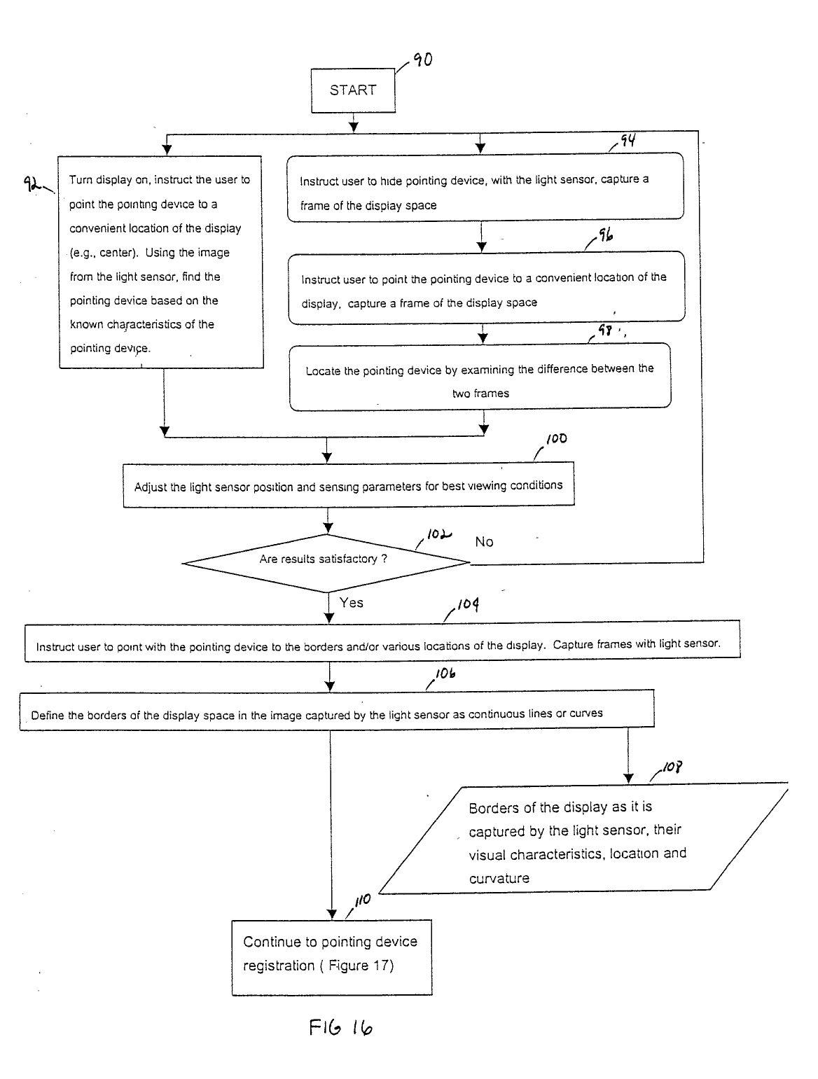

The method for the virtual display case is defined by the flowcharts in FIGS. 16 and 17. In FIGS. 16 and 17, after the start step 90, two alternate paths or processes are presented each leading to step 100. The system can follow either path, namely 92 or 94. Step 94 then proceeds to step 96 and 98. The system or the user can turn the display on, at which point the system instructs the user to point the pointing device to a convenient or specific area or location of the display (e.g., center). Using the image from the light sensor or camera, the system locates the pointing device based on the known characteristics of the pointing device (step 92). On the other hand, the user can be instructed to first hide the pointing device, and using the light sensor or camera, the system captures a frame of the display space (step 94), second the user can be instructed to point the pointing device to a convenient or specific location of the display, and using the light sensor or camera, the system captures a frame of the display space (step 96), third the system locates the pointing device by examining the difference between the two frames (step 98). After these steps the system or the user can adjust the light sensor position, viewing angle and sensing parameters for best viewing conditions (step 100) and then check whether the results are satisfactory (step 102). If not satisfactory, the user or the system returns to step 90. If the results are satisfactory, in step 104 the system instructs the user to point with the pointing device to the borders and/or various locations of the display and captures frames with the light sensor or camera. Then, the system defines the borders of the display space in the image captured by the light sensor or camera as continuous lines or curves (step 106). The borders of the display, as they are captured by the light sensor or camera, their visual characteristics, location, and curvature (step 108) are outputted or stored. Step 110 continues to pointing device registration. Note that the steps 112 through 118 can be skipped if distinguishing characteristics of the pointing device have already been computed to a satisfactory degree or are known a priori. Moreover, the order of the processes (92 through 110) and (112 through 120) may be changed if it is desirable to register the pointing device first and then set the display space. Step 112 instructs user to point with the pointing device to the borders and/or various locations of the display. The system captures frames with the light sensor or camera. After the steps, the user or the system can adjust the light sensor position, viewing angle, and sensing parameters for best viewing conditions (step 114). The user or the system then checks whether the results are satisfactory (step 116). It not satisfactory, the user or the system returns to step 114. If the results are satisfactory, the system determines the characteristics of the pointing device that distinguish it from the rest of the virtual display by observing it via the light sensor or camera against the background of the virtual display. The system or user can then adjust light sensor position, viewing angle, and sensing parameters for optimum operation (step 118). Distinguishing characteristics of the pointing device against the variety of display backgrounds are outputted or stored (step 120). Having completed the steps 118 and 120, the system can continue to compute the mapping between the display space registered by the light sensor and the computer display (step 122).

In both the real and the virtual display space cases, the system uses a particular method for detecting the display or the virtual display space. In the first case, usually, the actual image that is on the display is known to the system, so the light sensor can be directed to locate it, automatically by way of (i) cropping a large high resolution image, or (ii) a pan/tilt/zoom mechanism under the control of the system. Alternately, the user can adjust the viewing field of the sensor. The system will operate most optimally if the field of view of the light sensor contains the whole display, as large as possible, but without any part of the display being outside of the field of view. In the second case as illustrated in the flowcharts of FIGS. 16 and 17, the light sensor or camera cannot register the real display, but the virtual display space. In order to operate successfully, the light sensor must have the pointing device in its field of view at all or nearly all times that the user is employing the system. In this case, too, the system needs to compute the dimensions of the space where the pointing device will be, i.e., the virtual display space. The system could be set automatically based on the recognition of objects in the virtual display space, and their relative dimensions, especially in relation to the size of the pointing device. Alternately, the user can manually do the same by adjusting the position and the field of view of the light sensor or camera. The virtual display case may call for a relative address scheme, rather than an absolute addressing scheme. Relative addressing may be practical in this case since the user is not necessarily pointing to the actual space where he/she desires to point to or cause the computer's pointer to be moved to.

Following the establishment of the correct field of view for the real display or the virtual display space, at least one view of the same is registered. This is often in the form of a snapshot or acquired data or image frame from the light sensor. The related data output from the light sensor can be formatted in a variety of ways, but the method should be able to construct a one or two-dimensional image from the acquired data which maintains the spatial relationship of the picture elements of the light sensor (and consequently the scene). This one snapshot may be followed by one or more additional snapshots of the real or the virtual display space. One example may involve capturing two images, one with the display on and the other with the display off. This may be an easy way of finding the location and boundary contours of the display, as well. Additional snapshots could be taken but this time with or without the pointing device activated and in the view of the light sensor. The user may be instructed to point to different locations on the display to register the pointing device, its distinguishing characteristics, such as the light intensity it generates or registers, at the light sensor, its color, shape, size, motion characteristics etc. (as well as its location) against a variety of backgrounds. Note that the acquisition of the image with and without the pointing device may be collapsed into a single acquisition, especially if the characteristics of the pointing device are already known or can readily be identified. Note that the capture of images can happen very quickly without any human intervention in the blink of an eye. The most appropriate time to carry out these operations is when the system is first turned on, or the relative positions of its elements have changed. This step can also be carried out periodically (especially of the user has been idle for some time) to continuously keep the system operating in an optimum manner.

Using the images captured, the system determines the outline of the display or the virtual display space, and the characteristics of the pointing device that render it distinguishable from the display or the virtual display space in a way identifiable by the system. The identification can be based on one or more salient features of the pointing device or its reflection on the display, such as but not limited to color, (or other wavelength-related information), intensity (or luminance), shape or movement characteristics of the pointing device or its reflection. If the identified pointing device (or reflection thereof) dimensions are too large or the wrong size or shape for the computer pointer, a variety of procedures can be used to shrink/expand/or reshape it. Among the potential ways is to find a specific boundary of the pointing device (or its reflection) on the display. Another method of choice is to compute the upper leftmost boundary of the pointing device (for right handed users), or the upper rightmost boundary of the pointing device (for left handed users), or the center of gravity of the pointing device or its reflection. A procedure based on edge detection or image moments, well-known to those skilled in the art of image processing, can be used for this, as well as many custom procedures that accomplish the same or corresponding results. FIGS. 19a-19h illustrate how the reflection of a pointing device (in this case laser pointer light source pointed towards a wall) can be identified traced by use of center of gravity computations. The figures show this under two conditions, namely in a lit (FIGS. 19a-19d) and a dark room (FIGS. 19e-19h). The position of the center of the light spot (marked with an “x”) can be computed at each frame or at selected number of frames of images provided by the light sensor. The frames in the figure were consecutively acquired at a rate of 30 frames per second and are shown consecutively from left to right in the figure.

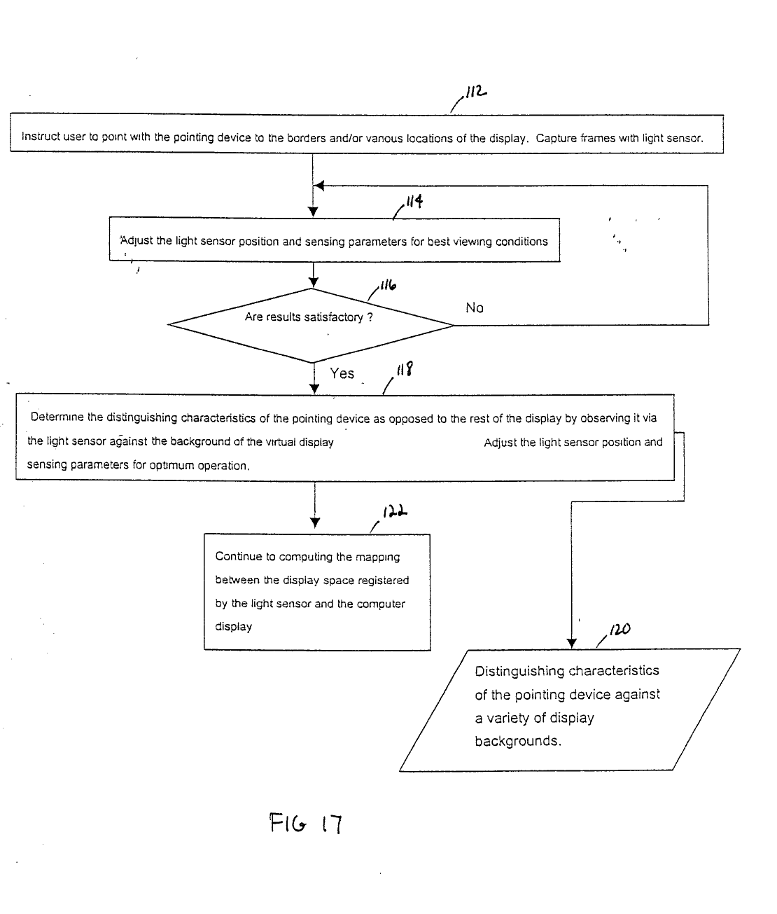

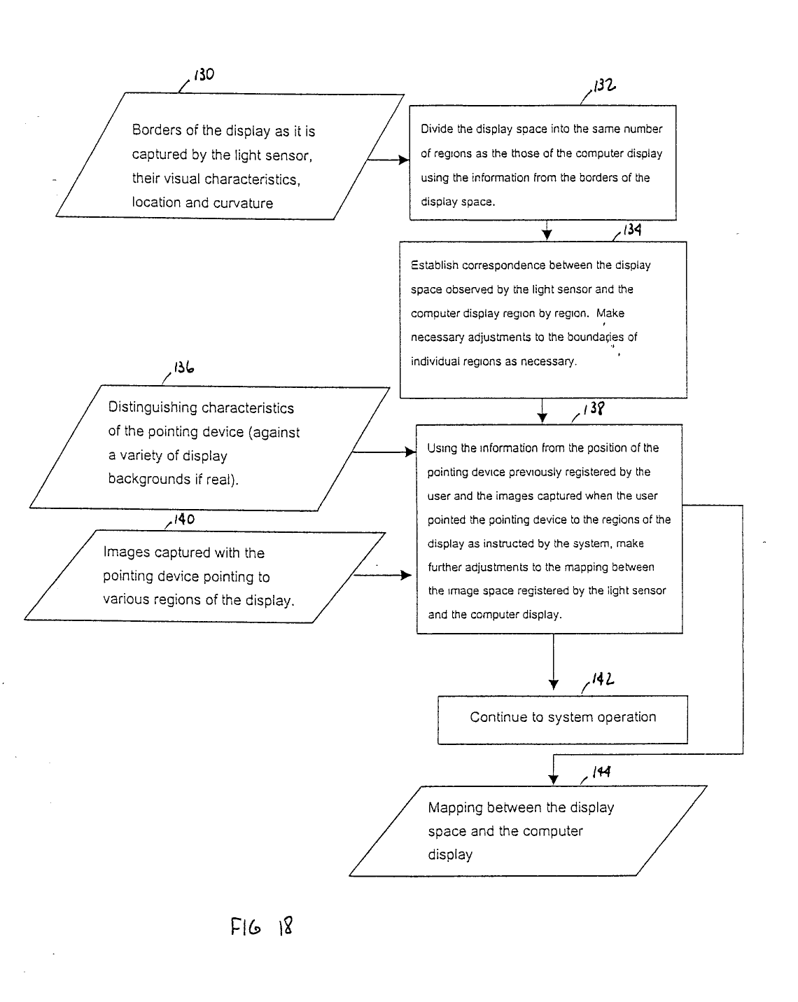

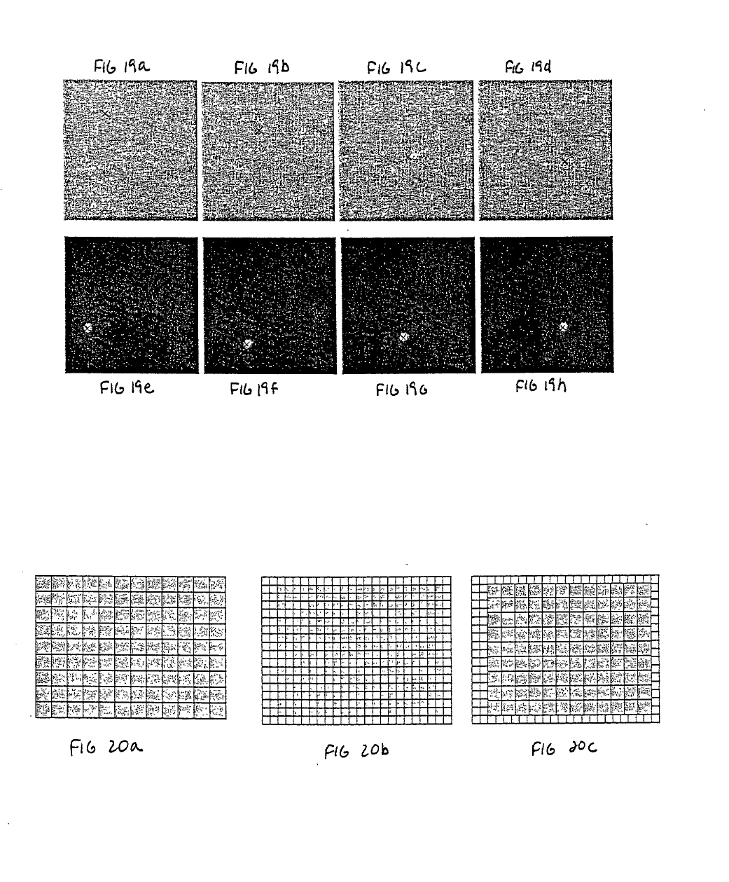

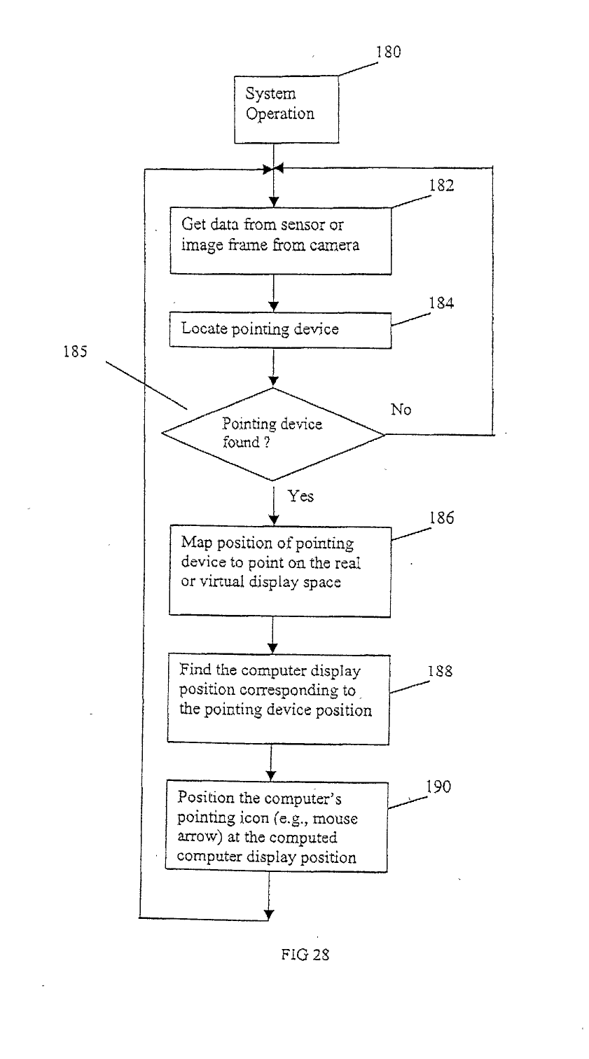

A flowchart of the method for establishing the correspondence between the position of the pointing device in relation to the display as it is registered by the light sensor and its position in relation to the computer display space in case of a real or virtual display is shown in FIG. 18. First, step 132 divides the display space into the same number of regions as those of the computer display using the information from the borders of the display space. (The output in step 66 or 108 is used as input 130 to step 132.) In step 134 the system establishes the correspondence between the real or virtual display space observed by the light sensor and the computer display region by region, and makes necessary adjustments to the boundaries of individual regions as necessary. Then in step 138, the system can make adjustments to the mapping computed in step 134 by using the information from the position of the pointing device previously registered by the user and the images captured when the user pointed the pointing device to the regions of the display as instructed by the system. This can further improve the mapping between the image space registered by the light sensor and the computer display. (The outputted data from steps 88 or 120 is input 136 to step 138.) Images captured with the pointing device pointing to various regions of the display (step 140) is also input to step 138. Note that step 138 may be skipped, however, if the mapping computed in 134 is sufficient. Mapping between the display space and the computer display is outputted (step 144). The user continues to system operation in step 142. System operation is illustrated in FIG. 28.

A distinction must be made for purposes of clarity between the display or the virtual display space that is registered by the light sensor and the computer display space: The computer display space is defined by the computer or the device that is connected to the display. It is defined, for example, by the video output of a PC or a settop box. It is in a sense the “perfect image” constructed from the video output signal of the computer or the visual entertainment device connected to the display. The computer display space has no distortions in its nominal operation and fits the display apparatus nearly perfectly. It has the dimensions and resolution set by the computer given the characteristics of the display. As an example, if you hit the “Print Screen” or “PrtScr” button on your PC keyboard, you would capture the image of this computer display space. This is also what is depicted in FIG. 20a as a 9×12 computer display.

The display or the virtual display space that is registered by the light sensor, on the other hand, is a picture of the display space. This is also what is depicted in FIG. 20b. Being a picture registered by an external system, it is subject to distortions introduced by the camera or the geometry of the system elements relative to each other. A rather severely distorted rendition of the display space obtained from the light sensor is depicted in FIG. 21b.

Interaction with the display and/or the device that the said display is connected to requires that a correspondence be established between the display space (whether real or virtual) as it is registered by the light sensor and the computer display space.

This correspondence between the actual display space and the registered real display space can be established (i) at system start time, or (ii) periodically during system operation, or (iii) continuously for each registered image frame. In FIGS. 20a-20c, a simple example of how the said correspondence can be established is illustrated. For the purpose of this example, assume that the actual display space is composed of a 9×12 array of picture elements (pixels) and that the light sensor space is 18×24 pixels. In this simple case, the display falls completely within the light sensor's view in a 16×21 pixel area, and is a perfect rectangle not subject to any distortions. This 16×21 pixel area can be partitioned into a 9×12 grid of the display space, thus establishing correspondence between the actual (9×12 pixel display) and the image of the display acquired by the light sensor.

In practical operation, the image(s) of both the display and the pointing device (or its reflection) will be subject to many types of distortions. Some of these distortions can be attributed to the geometry of the physical elements, such as the pointing device, the display, the viewing light sensor, and the projector (if applicable). Further distortions can be caused by the properties of the display surface and imperfections of the optical elements, e.g., lens, involved. In cases where these distortions are significant, for successful operation of the system, their effects need to be considered during the establishment of the display-image correspondence. An illustrating example is given in FIGS. 21a-21c. Although a more complex correspondence relationship exists in this severely distorted case, the outline of the procedure for determining it remains the same. At least one picture of the real display space is taken. The method searches the real display space for a distorted image of the computer display space (which is known). The nature of the distortion and the location of the fit can be changed during the method until an optimum fit is found. Many techniques known in the art of image and signal processing for establishing correspondence between a known image and its distorted rendition can be used. Furthermore, the use of one or more special screen images can make the matching process more effective in the spatial or the frequency domain (e.g., color block patterns or various calibration images, such as, but not limited to the EIA Resolution Chart 1956, portions of the Kodak imaging chart, or sinusoidal targets). Another simplifying approach is to take two consecutive images, one with the display off and the other with the display on. The difference would indicate the display space quite vividly. The various light sources (overhead lights, tabletop lights, sunlight through a window) can introduce glares or shadows. These factors, too, have to be taken into consideration.

The captured image(s) can be processed further to gauge and calibrate the various settings of the display and the light sensor. This information can be used to adjust the display and the light sensor's parameters for both the optimum viewing pleasure for the user and the optimum operation of the system.

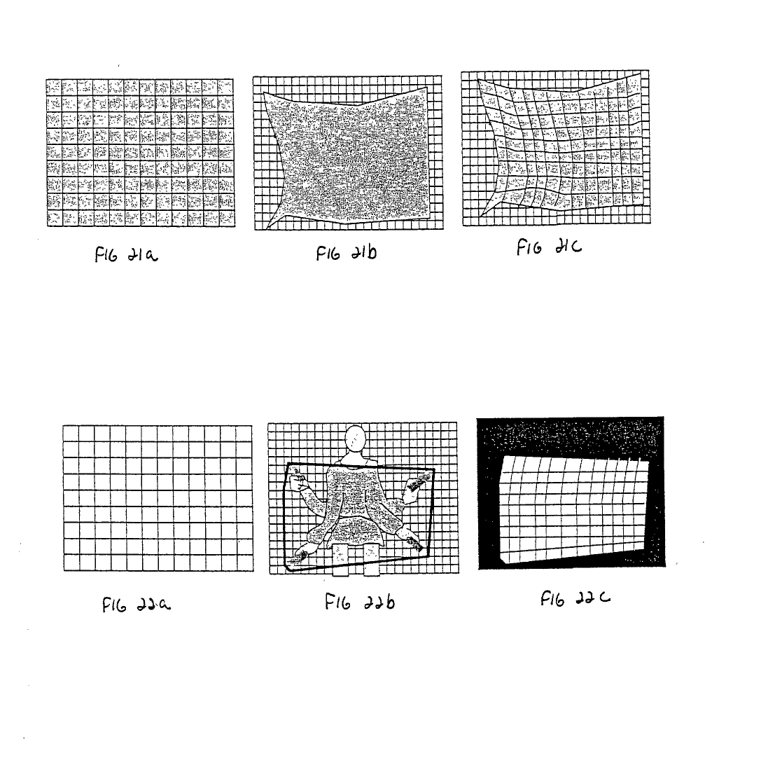

If the system is being used without the light sensor having in its field of a view the display (i.e., the virtual display space case), the image captured by the light sensor is the rendition of the environment from which the pointing device will be used. In this case establishing correspondence between the virtual display space and the computer display requires a different approach illustrated in FIGS. 22a-22c.

In the illustration (FIGS. 22a-22c), the computer display is a 9×12 pixel area as before. The light sensor cannot view the real display (for reasons such as those depicted in FIG. 13), but instead views the so-called virtual display —the vicinity of where the designated pointing device can be found. The reach of the pointing device in the user's hands defines the virtual display area. This range can be defined automatically or manually during the setup of the system. The user can point to a set of points on the boundary of the virtual display area while being guided through a setup routine 92, 94, 96, and 104. The user can also be guided to point to other regions of the computer display, such as the center for better definition of the virtual display space 104, 112.

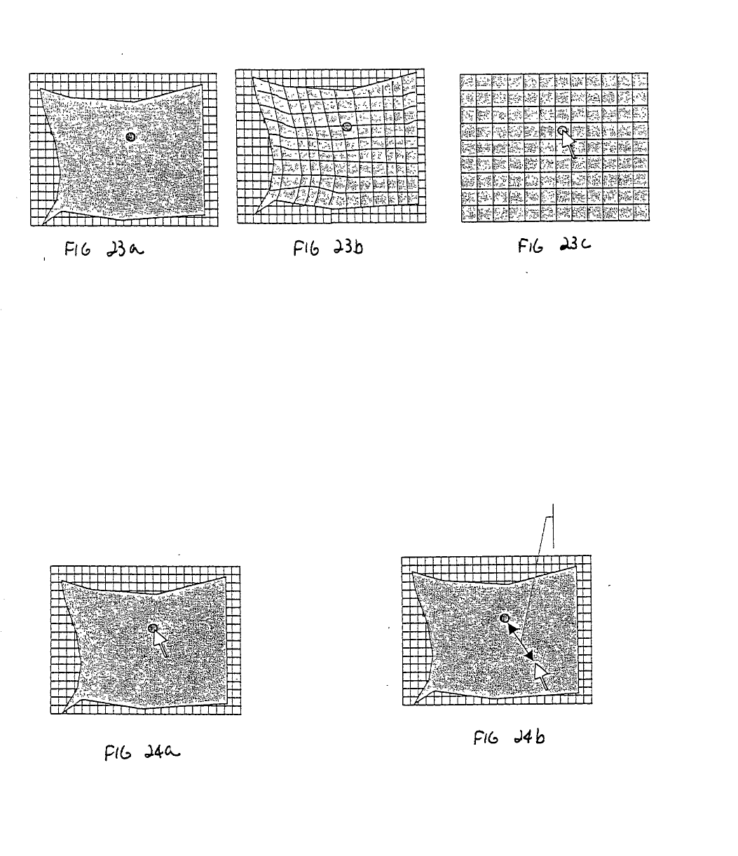

To successfully use the pointing device, in addition to the correspondence between the computer display space and the real or virtual display space registered by the image sensor, one also needs to establish the correspondence between the pointing device and computer display locations. For this, the method for detecting the display and the pointing device on or in relation to the display, must be combined with the method for establishing correspondence between the computer and registered display spaces described in this section. An illustrative example is given in FIGS. 23a-23c wherein establishing correspondence between the position of the pointing device (or its reflection on the display in this case) in relation to the image of the real display and the computer display and positioning of the pointer accordingly in a complex (severely distorted) case. In this case, the pointing device is a laser pointer. The detected position of the reflection of the light from laser pointer is found to be bordering the display locations (3,7) and (4,7) in FIG. 23b. The center of gravity is found to be in (4,7) and thus the pointer is placed inside the computer display pixel location (4,7) as illustrated in FIG. 23c.

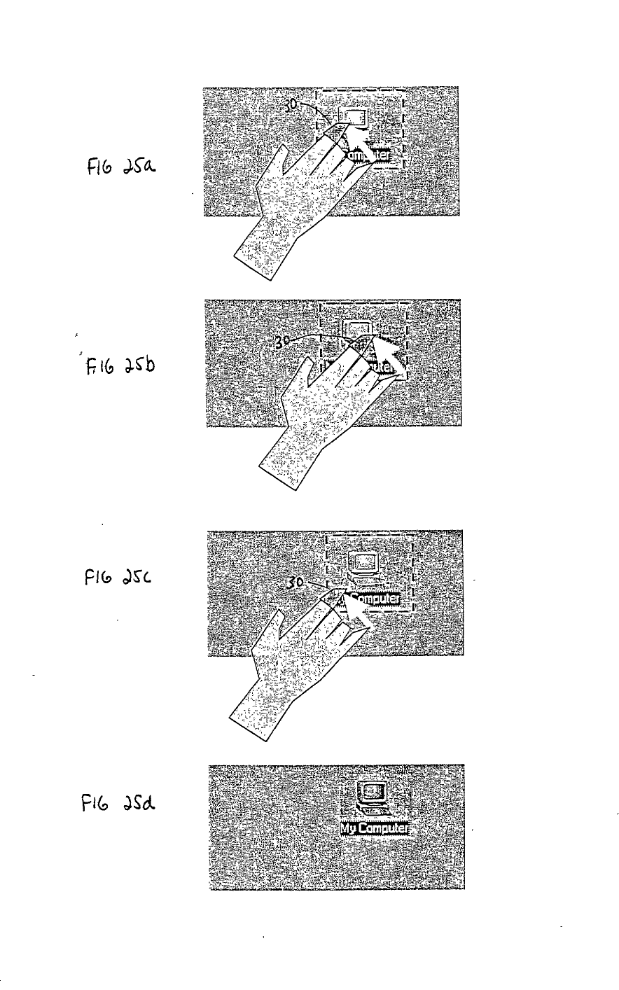

The method for correcting the offsets between (i) the position of the pointing device or reflection thereof on the display as observed by the user or by the light sensor, and (ii) the position of the pointer on the computer display space applies only to the real display case. This correction need not be made for the virtual display case. Ideally, if all the computations carried out to establish correspondence between the image of the real display registered by the light sensor and the computer display were completely accurate, the position of the pointer device (or reflection thereof) and the position of the pointer on the screen would coincide. This may not always be the case, especially in case of more dynamic settings, where the light sensor's field of view and/or the display location change. In FIGS. 24a-24b, an acceptably accurate (FIG. 24a) and an unacceptably inaccurate (FIG. 24b) positioning of the pointer are shown.

Generally speaking, there are three sources of errors. These are:

(1) Static errors that arise due to

a. inaccuracy in the correspondence mapping, and

b. inaccuracy due to quantization errors attributable to incompatible resolution between the display and the light sensor.

(2) Dynamic errors that arise out of the change in the geometry of the hardware, as well as the movement of the pointing device or its reflection on the display.

(3) Slow execution of the system where the computations do not complete in time and the computer pointer lags behind the pointing device.

These errors can be corrected by capturing an image of the display with the pointer on the display, identifying (i) the location of the pointing device on the display and (ii) the location of the computer's pointer representation (e.g., pointer arrow) in the captured image, identifying the disparity between (i) and (ii) and correcting it. A variety of known methods, such as feedback control of the proportional (P), and/or proportional integral (PI), and/or proportional integral derivative (PID) variety can be used for the correction step. More advanced control techniques may also be used to achieve tracking results.

In addition to positioning a pointer on the display, the user may also select an item, usually represented by a menu entry or icon. A method for selecting or highlighting a specific item or icon on the display applies to both the real and the virtual display case. In some computer systems, simply positioning the mouse pointer on the item or the icon selects the item. Examples are with rollover items or web page links. In these cases, no additional method is required to highlight the item other than the positioning of the computer pointer upon it.

In other cases, further user action is required to select or highlight an item. A common method of selecting or highlighting a specific item or icon using a conventional desktop mouse is by way of a single click of the mouse. With the system of this invention a method equivalent to this “single click” has to be defined. This method can be defined a priori or left for the user to define based on his/her convenience or taste.

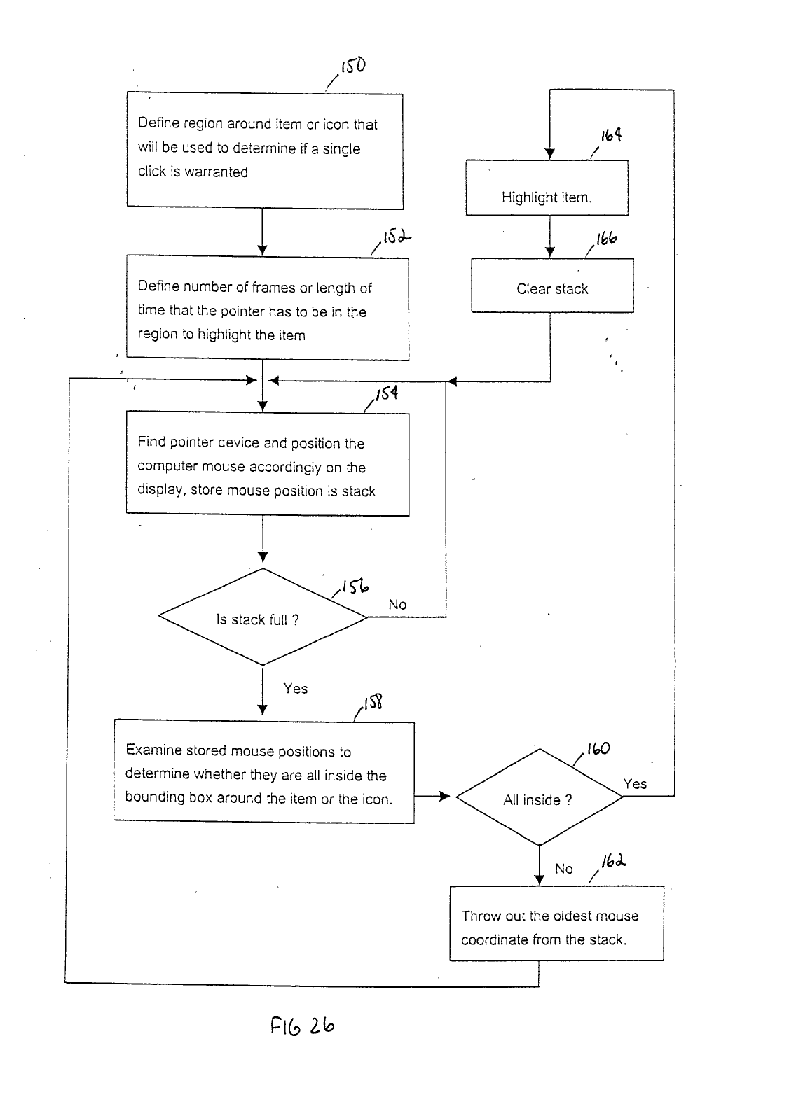

An example method for a single click operation of the invention can be holding the pointing device steady over the item or in the vicinity of the item for a programmable length of time. For an example illustration of the method FIGS. 25a-25d show an example method for selecting or highlighting an item on the display. Because the pointer has been observed within the bounding box (dashed lines) of the icon for set number of frames (three frames in this case) the icon is selected. This amounts to a single click of the conventional computer mouse on the icon. To accomplish this, the image or frames of images from the light sensor are observed for that length of time and if the pointing device (or the computer's pointer, or both) is located over the item (or a tolerable distance from it) during that time, a command is sent to the computer to highlight or select the item. The parameters such as the applicable length of time and the tolerable distance can be further defined by the user during the set up or operation of the system as part of the options of the system. For the corresponding flowchart see FIG. 26. The system first defines region around item or icon that will be used to determine if a single click is warranted (step 150). In step 152 the system defines the number of frames or length of time that the pointer has to be in the region to highlight the item. In step 154 the system finds the pointer device and using the mapping between the display space and the computer display 144 positions the computer mouse accordingly on the display and stores the mouse position in a stack. The system then checks whether the stack is full (step 156). If the stack is not full, the system returns to step 154. If the stack is full, the system examines the stored mouse positions to determine whether they are all inside the bounding box around the item or the icon (step 158). The system checks if positions are all inside (step 160). If yes, the system then can highlight the item (step 164) and clear stack (step 166) before returning to step 154. If the positions are not all inside, the user can throw out the oldest mouse coordinate from the stack (step 162), and then return to step 154.

Another example is to define a pointing device symbol, stroke, or motion pattern, which can also be identified by the system by accumulating the positions at which the pointing device (or the computer pointer, or both) was observed. For example, drawing a circle around the item or underlining the item with the pointing device can be the “pointer symbol” that selects that item. To accomplish this, the image or frames of images from the light sensor are observed for an appropriate length of time and the path of the pointing device is analyzed to decide whether it forms a circle or if it underlines an icon or item on the display. A procedure similar to that outlined in FIG. 26 can be used, this time to analyze the relationship of or the shape defined by the points at which the pointing device (or the computer pointer, or both) has been observed. The speed with which such strokes must be carried out can also be defined by the user much the same way that a user can vary the double click speed of a conventional desktop mouse.

In most current computers, this positioning highlights the selected item, or changes its foreground and background color scheme of the said item to indicate that it has been selected. Note that this selection does not necessarily mean that the process or the program associated with that item has been activated. Such activation is discussed hereafter.

The method for activating a specific process, program, or menu item represented on the display applies to both the real and the virtual display case.

In addition to positioning a pointer on the display and selecting an item, one may also activate a process, a program or menu item represented on the display. In some computer systems or in certain programs or various locations of the desktop of a computer, simply a single click of the mouse button, as discussed regarding a method for selecting or highlighting a specific item or icon on the display on the item activates the program or the process defined by the item. Examples are web page links, many common drawing menu items, such as paintbrushes, and the shortcuts at the task bar of the Windows95 or Windows98 desktop. In these cases, no additional method is required to activate a process or a program other than that which is required for selecting or highlighting an item.

A common method of activating a program or process using a conventional desktop computer mouse is by way of a double clicking of the mouse button. With the system of this invention a method equivalent to this “double click” has to be defined. This method can be defined a priori or during the operation of the system.

An example method for a double click operation can be holding the pointing device steady over the item or in the vicinity of the item for a programmable length of time. This can be coordinated with the same type of method described in the previous section for a single mouse click. After holding the pointing device steady over an item for the length of time required to define a single mouse click has elapsed and consequently a command for a single mouse click is in fact sent to the computer, holding the pointing device steady for additional length of time can send a second subsequent “click” to the computer, which when done with a certain time after the first such command, would constitute a “double click.” This procedure is currently used by conventional computers, i.e., there is not necessarily a “double click” button on the conventional computer mouse. A double click is defined by two single clicks, which occur within a set number of seconds of each other. The length of time between two clicks can be set by the user using the conventional mouse program already installed on the computer.

In addition to defining a “double click” as two closely spaced single clicks, one can define a pointing device symbol, stroke or motion pattern to signify a double click. This pattern, too, can be identified by the system by accumulating the positions at which the pointing device was observed. For example, drawing a circle around the item could signify a double click whereas underlining the item with the pointing device could signify a single click. As before, to accomplish this, the image or frames of images from the light sensor are observed for an appropriate length of time and the path of the pointing device is analyzed to decide whether it forms a circle or if it underlines an icon or item on the display. The speed with which such strokes must be carried out can also be defined by the user much the same way that a user can vary the double click speed of a conventional desktop mouse.

The common PC mouse has two to three buttons, which respond to single or double clicks in different ways. There are also ways of using the pointer as a drawing, a selecting/highlighting or a dragging tool, for example, by holding down the mouse button. The more recent PC mouse devices also have horizontal or vertical scroll wheels. Using the system of this invention, the many functions available from the common PC mouse (as well as other functions that may be made available in the future) can be accomplished with only an ordinary pointing device. To accomplish this, one can identify associate a series of other types of commands that one commonly carries out with a conventional mouse, such as scroll (usually accomplished with a wheel on a conventional mouse), move or polygon edit (commonly accomplished with the middle mouse button on a conventional mouse), display associated menus with an item (usually accomplished by clicking the right button on a conventional mouse), as well as a myriad of other commands, with a series of pointer device strokes, symbols, or motion patterns. This association may be built into the system a priori, or defined or refined by the user during the use of the system. The association of strokes, symbols, or motion patterns using the pointing device is in a way analogous to the idea of handwritten character recognition used on a handheld computer with a stylus. The pressure sensitive pad on the handheld computer tracks and recognizes the strokes of the stylus. Similarly, the system of this invention can track and recognize the symbol that the pointing device is tracing in the real or virtual display space.

The types and numbers of pointing device strokes can be traded against the richness of display menu items. For example, one can define a pointer stroke or symbol such for scrolling down a screen (e.g., dragging the pointer device from top to bottom) or as simply another menu item, such as a forward button, on the display. In essence the pointer device can completely replicate all the functionality of the traditional PC mouse. It may also work with the traditional PC mouse in a complementary fashion.

The system of this invention can also be interfaced with external systems, such as those that are voice or touch activated, other buttons on the pointing device that communicate to the computer to carry out a single or double click, or some other operation. In these cases, the system would still define over which item or display region the said operation will be carried out, but the operation itself is communicated by another system. Imagine for example, bringing the pointing device over a menu button and then tapping the display (where a touch or tap sound detecting system sends a “click” command to the computer) or saying “click” or “click click” (where a voice activated system sends the appropriate command to the computer). During the whole time, the system of this invention defines the computer display coordinates over which the command is carried out.

Hereinafter is a discussion for a method for writing, scribing, drawing, highlighting, annotating, or otherwise producing marks on the display. So far the description of the methods of the invention have concentrated on selecting and activating processes associated with the menus or icons on the display. There are also many occasions on which the user would like to write or draw on the display in a more refined manner than one generally could with an ordinary mouse. There are many types of commercially available drawing tablets that one can attach to a conventional computer for this purpose. The system of this invention can be used to accomplish the same. Furthermore, the system of this invention can also function as an electronic whiteboard that can transmit to a computer the marks upon it. In contrast to the case with electronic white boards, when the system of this invention is used, no expensive special writing board is required.

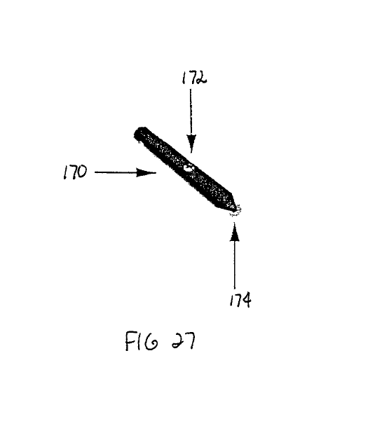

FIG. 27 shows a light pen 170 that can be used successfully with the system of this invention both as a pointing device and a drawing and writing instrument. The light pen 170 could be activated by holding down the power button 172 or by applying some pressure to its tip 174. Thus when the light pen 170 is pressed against a board on which the computer display is projected, the tip 174 would light up and would become easily identifiable to the system. Its light can be traced to form lines or simply change the color of the pixels it touches upon. The system can be interfaced with common drawing programs which allow the user to define a set of brush colors, lines, drawing shapes and other functions (e.g., erasers, smudge tools, etc.) that enrich the works of art the user can thus create.

Note that throughout no actual mark is made on the display or the projection space. Moreover, no actual multi-colored pens or unique screen or surface are required. The same system could also be used on a blank board to capture everything the user writes or draws with the light pen. Because the light pen stylus is designed to function like a writing device, the user may conveniently and easily scribe notes directly onto the display without having to access a PC keyboard or target a sensor in order to annotate a presentation.

The annotations become part of the projected document as the user creates them since the presentation or drawing program adds them to the document that the user is creating almost instantaneously. The computer interfaced with the display in turn puts the resulting document to the display space. Furthermore, with the same LED stylus, the user may navigate through any other program or document. Best of all, this stylus capability can be a built-in feature of the overall system including the pointing functions. No additional special software is required since the system simply functions as a mouse or stylus at the same time. Other types of pointing devices can also be used for the same purpose.

Imagine as a potential application an instructor before a projected display. He or she is using the light pen to draw on the ordinary wall or surface onto which the display is projected using an LCD projector. Imagine that the training session contains an electronic training document as well as notes and illustrations scribbled by the instructor during the training session. Imagine again that all those notes and illustrations the instructor makes can be recorded as the instructor makes them on the board with the light pen. The final annotated document can be electronically stored and transmitted anywhere. The result is a superb instant videoconferencing, distance learning, documentation and interaction tool.

The same system can also be used for text entry - if the strokes can be recognized as letters or characters. This again is similar to the case where the strokes of the stylus on the pressure-sensitive writing area can be recognized as letters or characters.

The described method for writing, scribing, drawing, highlighting, annotating, or otherwise producing marks on the display mostly applies to the real display case. Despite that, some simple shapes can be drawn on a virtual display space. Since the user will immediately view the rendition or results of his/her marks, he/she can adjust the strokes of the pointing device accordingly.

Finally, in FIG. 28, a system operation flowchart is included to summarize the background or backbone process of the system. The system proceeds to system operation 180 from step 142. In step 182, the system acquires data from the sensor or one or more image frames from the light sensor or camera. In step 184, the system locates the pointing device. This step usually requires analysis of the data or image frame or frames acquired in 182. The analysis is made by using the distinguishing characteristics of the pointing device against the real display 88 or the same against the virtual display 120. If the system fails to locate the pointing device, it will go back to step 182. If it locates the pointing device it will move to step 186. In step 186, the system maps the position of pointing device to a point on the real or virtual display space. Especially if the pointing device spans over multiple regions, this step may require that the borders of the pointing device, or its center of gravity be identified. In step 188, the system finds the computer display position corresponding to the pointing device position. This step requires the mapping between the display space and the computer display 144. In step 190, the system positions the computer's pointing icon (e.g., mouse arrow) at the computed computer display position. Note that the step 190 may be skipped or suppressed if the system is engaged in another task or has been programmed not to manipulate the computer's pointing icon.

Methods for implementing the functions normally associated with a computer mouse, e.g., selecting an item on the display, starting a process associated with an item on the display, dragging or moving objects across the display, drawing on the display, scrolling across the display, are processes that emanate from this backbone process, in particular from steps 186, 188, and/or 190.

What is claimed is:

1. A system for interacting with displays and all devices that use such displays comprised of
a. a display,
b. a sensor or camera,
c. a pointing device that can be registered by the sensor or camera,
d. a method for detecting the pointing device,
e. a method for establishing the mapping between the position of the pointing device and a corresponding location on the display.

2. A system according to claim 1 wherein the sensor or camera, in addition to registering the image of the pointing object, can also register at least one of (i) the image of the display and (ii) the reflection or effect that the pointing device can produce on the display.

3. A system as defined by claim 1 which commands the positioning of a pointing icon on the display.

4. A system according to claim 1 wherein the pointing device is a part of the human body such as a hand or a finger, or an ornament or device worn on the human body such as a glove or thimble.

5. A system according to claim 1 wherein the pointing device is used to point to regions of the display by way of changing its position, attitude, or presentation.

6. A system according to claim 1 wherein the pointing device is used to define a particular point or region on the display.

7. A system according to claim 1 wherein the pointing device is used to define a vector on the plane of the display that indicates a direction and magnitude relative to or with respect to an item on the display or a region of the display.

8. A system according to claim 3 wherein the pointing icon on the display can be registered by the sensor or camera.

9. A system according to claim 8 which also includes a method for correcting the offsets between (i) the position of the pointing device, or reflection, or effect thereof on the display as observed by the user or by the sensor or the camera, and (ii) the position of the pointer icon on the display.

10. A system as defined by claim 1 which also includes at least one of the following:
a. a method for selecting or highlighting a specific item or icon on the display,
b. a method for activating a specific process, program, or menu item represented on the display, and
c. a method for writing, scribing, drawing, highlighting, annotating, or otherwise producing marks on the display.

11. A method for detecting the pointing device comprising
a. retrieval of data or image from a sensor or camera, and
b. analysis of the data or image from the sensor or camera to locate the pointing device in the data, or locating at least a set of the picture elements in the image that comprise the rendition of the pointing device.

12. A method according to claim 11 wherein the characteristics that distinguish the pointing device from other objects in the data from the sensor or the image from the camera are known a priori.

13. A method according to claim 11 wherein the characteristics that distinguish the pointing device from other objects in the data from the sensor or the image from the camera are determined based analysis of at least one set of the data acquired from the sensor or one image acquired from the camera.

14. A method according to claim 13 wherein the characteristics that distinguish the pointing device from other objects, whose rendition are present in the data from the sensor or in the image from the camera, is obtained by
a. acquiring at least two sets of data from the sensor or at least two images from the camera, one with the pointing device in view of the sensor or the camera and one without, and
b. comparing the two sets with one another.

15. A method according to claim 11 wherein adjustments or modifications are made to the position, sensitivity, and other settings of the sensor or the camera pursuant the analysis of the data or image retrieved from the sensor or the camera.

16. A method according to claim 11 wherein at least part of the procedures for the method is carried out using at least in part the computing mechanisms available on one or more of the following: the display, or the sensor or camera, or the pointing device, or the device producing the signal shown on the display, or the device producing the pointing icon on the display.

17. A method for establishing the mapping between the set of positions that a pointing device can take and the set of corresponding locations on the display comprising:
a. defining the range of positions that the pointing device can assume,
b. defining the boundaries of the range of positions that the pointing device can take with geometric representations,
c. transforming the geometric representation of the arrangement of regions on the display so that it fits optimally into the boundaries of the range of positions that the pointing device can take.

18. A method according to claim 17 wherein the range of positions that the pointing device may assume is defined by querying the user to point to a set of points on the display.

19. A method according to claim 18 wherein the range of positions that the pointing device can assume is defined by the boundary contours of the display as they are registered by the sensor or the camera.

20. A method according to claim 19 wherein at least one special display image is used to establish the mapping between the positions that a pointing device can take and a corresponding locations on the display.

21. A method according to claim 17 wherein at least part of the procedures for the method is carried out using at least in part the computing mechanisms available on one or more of the following: the display, or the sensor or camera, or the pointing device, or the device producing the signal shown on the display, or the device producing the pointing icon on the display.

22. A method for detecting the display comprising
a. retrieval of data or image from a sensor or camera, and
b. analysis of the data or image from the sensor or camera to locate the display in the data, or locating at least a set of the picture elements in the image that comprise the rendition of the display in the image.

23. A method according to claim 22 wherein the characteristics that distinguish the display from other objects in the data from the sensor or the image from the camera are known a priori.

24. A method according to claim 22 wherein the characteristics that distinguish the display from other objects in the data from the sensor or the image from the camera are determined based on analysis of at least one set of the data acquired from the sensor or one image acquired from the camera.

25. A method according to claim 22 wherein the display refers to the range of positions that the pointing device can take.

26. A method according to claim 24 wherein the characteristics that distinguish the display from other objects, whose rendition are present in the data from the sensor or in the image from the camera, is obtained by
a. acquiring at least two sets of data from the sensor or at least two images from the camera, one with the display off in view of the sensor or the camera and one with the display on, and
b. comparing the two sets with one another.

27. A method according to claim 22 wherein adjustments or modifications are made to the position, sensitivity, and other settings of the sensor or the camera pursuant the analysis of the data or image retrieved from the sensor or the camera.

28. A method according to claim 22 wherein at least part of the procedures for the method is carried out using at least in part the computing mechanisms available on one or more of the following: the display, or the sensor or camera, or the pointing device, or the device producing the signal shown on the display, or the device producing the pointing icon on the display.
